(19) United States
(12) Patent Application Publication
(10) Pub. No.: US 2015/0243031 A1
(43) Pub. Date: Aug. 27, 2015

(54) METHOD AND DEVICE FOR DETERMINING AT LEAST ONE OBJECT FEATURE OF AN OBJECT COMPRISED IN AN IMAGE

(71) Applicant: Metaio GmbH, Munich (DE)

(72) Inventors: Rajesh Narasimha, Plano, TX (US); Manjunath Narayana, Waltham, MA (US)

(73) Assignee: Metaio GmbH, Munich (DE)

(21) Appl. No.: 14/186,844

(22) Filed: Feb. 21, 2014

(51) Int. Cl. G06T 7/00; G06K 9/46

(52) U.S. Cl. CPC G06T 7/0042; G06K 9/4604

(57) ABSTRACT

A method and device is provided for determining at least one object feature of at least one object comprised in an image. The method includes providing an input image of at least part of the at least one object, estimating a coarse pose of the at least one object according to a trained pose model and at least part of the input image, selecting a feature detection model from a plurality of feature detection models, and determining at least one object feature position of the at least one object in the input image. The selected feature detection model includes a forest data structure including at least one decision tree having leaf nodes.

### BACKGROUND OF THE INVENTION

1. Technical Field

The present disclosure is related to a method and device for determining at least one object feature of at least one object comprised in an image in which an input image of at least part of the at least one object is provided.

2. Background Information

Determining a pose of an object in a known real environment or relative to a reference coordinate system, or localization of a camera in a known real environment is a common task in multiple application fields. For example, it may be used to determine the position of an object of interest in the real environment or to overlay virtual visual content (i.e. computer generated object) onto an object of interest in a real environment. The pose commonly describes a rigid 2D or 3D transformation including a translational part and/or a rotational part. Common approaches for pose estimation are based on computer vision techniques using one or more camera images of the object.

In a particular application, robust and accurate determination of a pose of a human face based on an image of the face is challenging. It may require to first robustly and precisely detect the face and/or facial features in the image, which is another challenging task. Face pose estimation is an important step in many application areas, such as human computer interaction, face analysis, and augmented reality. For example, gaze direction could be determined according to the estimated face pose for human computer interaction and face analysis. In augmented reality shopping applications, a virtual object, like a sun glasses or a hat, may be overlaid with an image of the face captured by a camera according to the face pose relative to the camera. Practically, many applications require real time processing of the face pose estimation in order to give end users acceptable experiences.

Different vision based face pose estimation methods have been proposed, such as using random forest according to Fanelli, Gabriele, Juergen Gall, and Luc Van Gool. “Real time head pose estimation with random regression forests.” Computer Vision and Pattern Recognition (CVPR), 2011 IEEE Conference on. IEEE, 2011) and using stereovision with model according Yang, Ruigang, and Zhengyou Zhang. “Model-based head pose tracking with stereovision.” Automatic Face and Gesture Recognition, 2002. Proceedings. Fifth IEEE International Conference on. IEEE, 2002.

Dantone M., Gall J., Fanelli G., and van Gool L., Real-time Facial Feature Detection using Conditional Regression Forests, IEEE Conference on Computer Vision and Pattern Recognition (CVPR'12), 2012 uses conditional regression forests to perform real-time facial feature detection by first estimating a coarse pose of a face and then choosing a proposed facial feature detection mode based on the coarse pose.

It would be desirable to provide a method and device for determining at least one object feature of at least one object of interest comprised in an image which is capable of improving an estimation of object features and object pose in the image.

### SUMMARY OF THE INVENTION

According to an aspect, there is disclosed a method of determining at least one object feature of at least one object comprised in an image, comprising providing an input image of at least part of the at least one object, estimating a coarse pose of the at least one object according to a trained pose model and at least part of the input image, selecting a feature detection model from a plurality of feature detection models according to the estimated coarse pose, determining at least one object feature position in the input image according to the selected feature detection model and at least part of the input image, wherein the selected feature detection model includes a forest data structure comprising at least one decision tree having leaf nodes, wherein at least part of the leaf nodes of the at least one decision tree is associated with statistics for at least one object feature position and statistics for at least one pose.

According to another aspect, there is disclosed a device for determining at least one object feature of at least one object comprised in an image, comprising at least one processing device which is configured to provide an input image of at least part of the at least one object, estimate a coarse pose of the at least one object according to a trained pose model and at least part of the input image, select a feature detection model from a plurality of feature detection models according to the estimated coarse pose, and determine at least one object feature position in the input image according to the selected feature detection model and at least part of the input image. The selected feature detection model includes a forest data structure comprising at least one decision tree having leaf nodes, wherein at least part of the leaf nodes of the at least one decision tree is associated with statistics for at least one object feature position and statistics for at least one pose.

The following aspects and embodiments as described below may be applied individually or in any combination with the aspects of the invention as described above and in any combination with other aspects and embodiments of the present invention as described below.

According to an embodiment, the method further comprises determining a refined pose of the at least one object according to the selected feature detection model and at least part of the input image.

According to an embodiment, the method further comprises providing a 3D model, determining object feature correspondences between object features in the input image and features of the 3D model, and determining an accurate pose of the at least one object according to the object feature correspondences.

Preferably, the at least one decision tree may be determined by using a machine learning method based on a plurality of training images of training objects which are associated with known image positions of object features of the training objects and known poses of the training objects. For example, each of the poses of the training objects includes at least one parameter indicative of a rotation.

For instance, the input image is an image of a real environment captured by a camera or is a synthetic image generated as captured by a camera. Particularly, at least one of the estimated coarse pose and the determined accurate pose may be relative to the camera.

Advantageously, the at least one object is a face, and the at least one object feature is a facial feature. For example, the facial feature is at least one of an eye corner, nose tip, mouth corner, silhouette of mouth, and silhouette of eye.

All embodiments, aspects and examples described herein with respect to the method can equally be implemented by the processing device being configured (by software and/or hardware) to perform the respective steps. Any used processing device may communicate via a communication network, e.g. via a server computer or a point to point communication, with a camera and/or any other components.

For example, the processing device (which may be a component or a distributed system) is at least partially comprised in a mobile device which is associated with a camera for capturing images of a real environment, and/or in a computer device which is adapted to remotely communicate with the camera, such as a server computer adapted to communicate with the camera or mobile device associated with the camera. The system according to the invention may be comprised in only one of these components, or may be a distributed system in which one or more processing tasks are distributed and processed by one or more components which are communicating with each other, e.g. by point to point communication or via a network.

According to another aspect, the invention is also related to a computer program product comprising software code sections which are adapted to perform a method according to the invention. Particularly, the software code sections are contained on a computer readable medium which is non-transitory. The software code sections may be loaded into a memory of one or more processing devices. Any used processing devices may communicate via a communication network, e.g. via a server computer or a point to point communication, as described herein.

### BRIEF DESCRIPTION OF THE DRAWINGS

Aspects and embodiments of the invention will now be described with respect to the drawings, in which:

FIG. 1 shows a flow diagram of a method according to an embodiment of the invention for determining an accurate pose of an object of interest.

FIG. 2 shows a workflow diagram of an embodiment of determining a trained pose model.

FIG. 3 shows a workflow diagram of an embodiment of determining a plurality of feature detection models.

FIG. 4 shows an embodiment of a forest structure.

FIG. 5 shows examples of patches extracted in an image.

FIG. 6 shows an embodiment of a system setup for determining an accurate pose of an object of interest according to an example of the invention.

FIG. 7 shows examples of images of a face locating at different poses.

### DETAILED DESCRIPTION OF THE INVENTION

In the following, embodiments and exemplary scenarios are described, which however shall not be construed as limiting the invention.

According to embodiments of the invention, estimation of object features and object pose in an image of at least part of an object of interest is improved by first estimating a coarse pose based on using a first trained model, determining image locations of the object features based on a second trained model chosen according to the estimated coarse pose, and then determining the object pose according to correspondences between the object features in the image and features in a 3D model.

In the prior art, there is no teaching to first estimate a coarse pose of an object, then determine object features according to the estimated coarse pose, and then determine an accurate pose according to the determined object for improving estimation. Dantone M., Gall J., Fanelli G., and van Gool L., Real-time Facial Feature Detection using Conditional Regression Forests, IEEE Conference on Computer Vision and Pattern Recognition (CVPR'12), 2012 uses conditional regression forests to perform real-time facial feature detection by first estimating a coarse pose of a face and then choosing a proposed facial feature detection mode based on the coarse pose. However, Dantone M., Gall J., Fanelli G., and van Gool L., Real-time Facial Feature Detection using Conditional Regression Forests, IEEE Conference on Computer Vision and Pattern Recognition (CVPR'12), 2012 does not propose to build feature correspondences between detected facial features and a 3D model for an accurate pose estimation. Another significant difference is that, according to aspects of the invention, there is proposed to perform joint feature location and pose training to train forest data structure and to online (i.e. during runtime of an application) detect feature locations and determine a refined pose based on the trained forest. Dantone M., Gall J., Fanelli G., and van Gool L., Real-time Facial Feature Detection using Conditional Regression Forests, IEEE Conference on Computer Vision and Pattern Recognition (CVPR'12), 2012, on the other hand, trains a forest based on feature location (not based on pose) and detects only object features based on the trained model.

The disclosed method is particularly suitable for estimating facial feature location in an image of a (human) face and further determining a face pose.

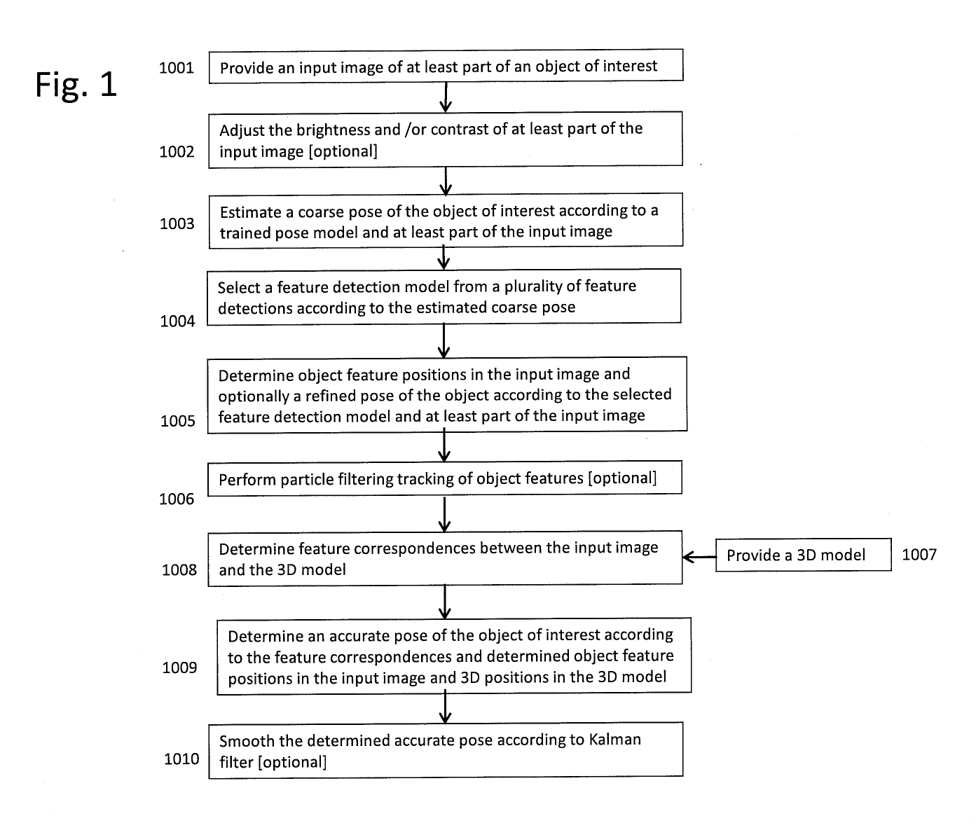

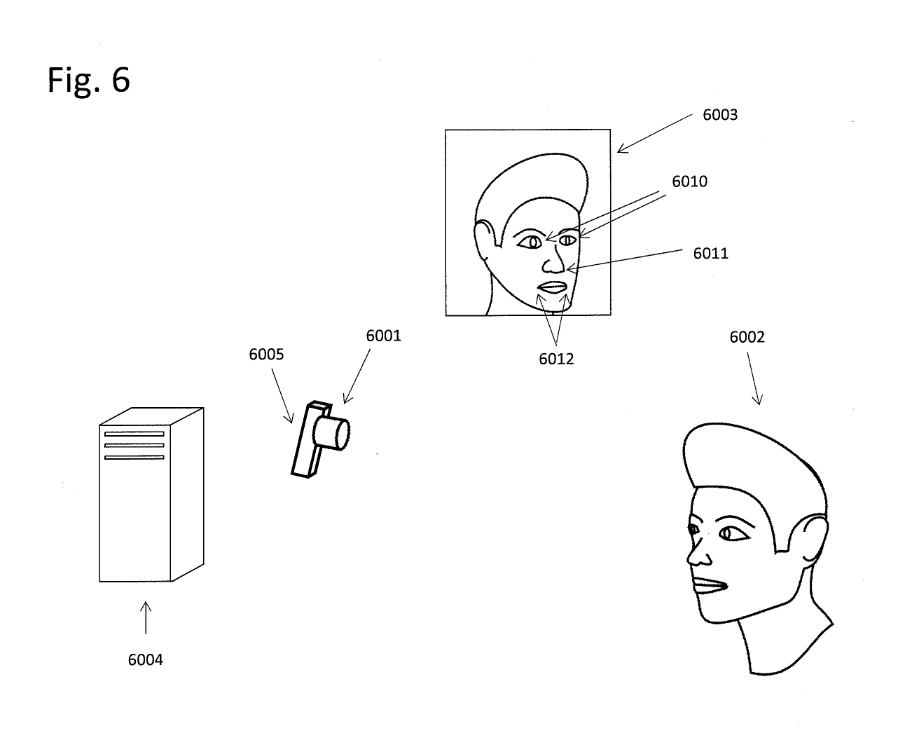

FIG. 1 shows a flow diagram of an embodiment of a method for determining an accurate pose of an object of interest. FIG. 6 shows an embodiment of a system setup for determining an accurate pose of a face relative to a camera. The system setup as shown can be used, in principle, in any system for determining object features and poses of an object of interest.

According to FIG. 6, a camera 6001 captures an input image 6003 of a face 6002. The camera 6001 may communicate with a processing device 6004 (e.g., of a computer or mobile device) via cable or wirelessly. The procedure and embodiments thereof as disclosed herein may be performed at least partly in the processing device 6004. The camera 6001 may be integrated into a mobile device 6005, such as a smartphone or mobile computer, comprising a processing device (not shown) where the procedure and embodiments thereof as disclosed herein may also be performed at least partly. The mobile device 6005 and processing device 6004 can build a distributed system, or they can perform the procedure individually. The processing device 6004 may be implemented in, e.g., a mobile device worn or held by the user, a server computer or in any of the cameras described herein. It may be configured by hardware and/or software to perform one or more tasks as described herein.

Referring to FIG. 1, step 1001 provides an input image of at least part of an object of interest. For example, the input image may be a real image captured by a camera or a synthetic image generated by a computer and as captured by a camera. Further, the synthetic image may be generated by projecting a 3D model of the object of interest onto a 2D plane according to perspective projection or orthogonal projection. The synthetic image generated according to the perspective projection could be equivalent to being captured by a pinhole camera. In one scenario shown in FIG. 6 of determining an accurate pose of a face 6002 relative to a camera 6001, the object of interest may be a human face 6002 and the input image is the image 6003.

Step 1002, which is optional, adjusts the brightness and/or contrast of at least part of the input image. The input image is tone-mapped to adjust for the illumination. It estimates the average brightness of the input image and adjusts the brightness and contrast of the object region. This could improve, both, the object detection and object feature estimation, particularly for the face detection and facial fiducial (i.e. object features) estimation.

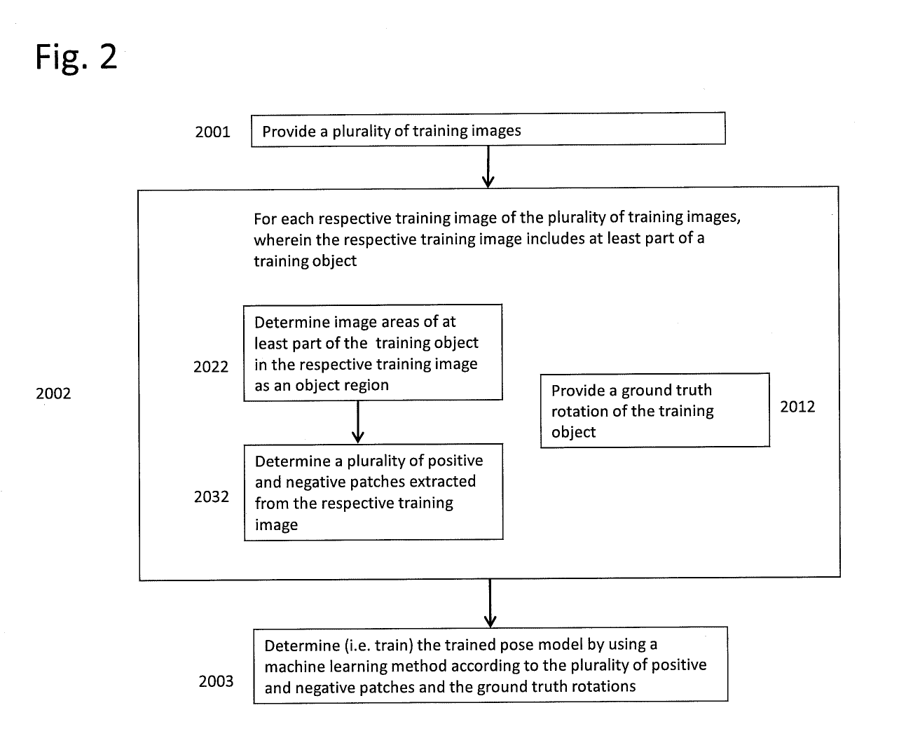

Step 1003 estimates a coarse pose of the object of interest according to a trained pose model and at least part of the input image. In one scenario where the object of interest is a face 6002 and the input image is captured by a camera 6001 as shown in FIG. 6, the estimated coarse pose of the face 6002 could be relative to the camera 6001. Further, the estimated coarse pose may only indicate a rotation between the face 6002 and the camera 6001. An embodiment of determining or constructing the trained pose model is illustrated in FIG. 2.

In the example shown in FIG. 6, given the wide variation that is observed in the location and orientation of facial landmarks for different poses of the face, it is useful to first estimate a coarse pose for the face 6002. Using a reasonable initial coarse estimate, the coarse pose could be subsequently refined to obtain the accurate pose.

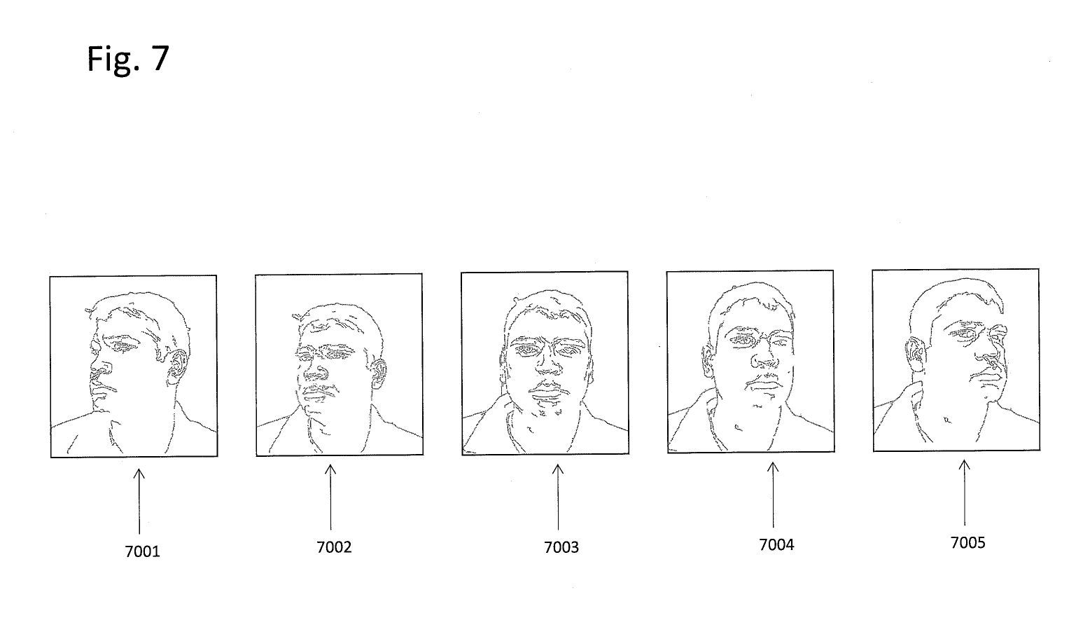

For the object of interest placed at different poses relative to the camera, the camera would capture respective different image appearances of the object of interest in the input image. FIG. 7 shows, for example, five images of a face captured by a camera locating at different poses relative to the face. Here, the captured face in the images has different face rotations.

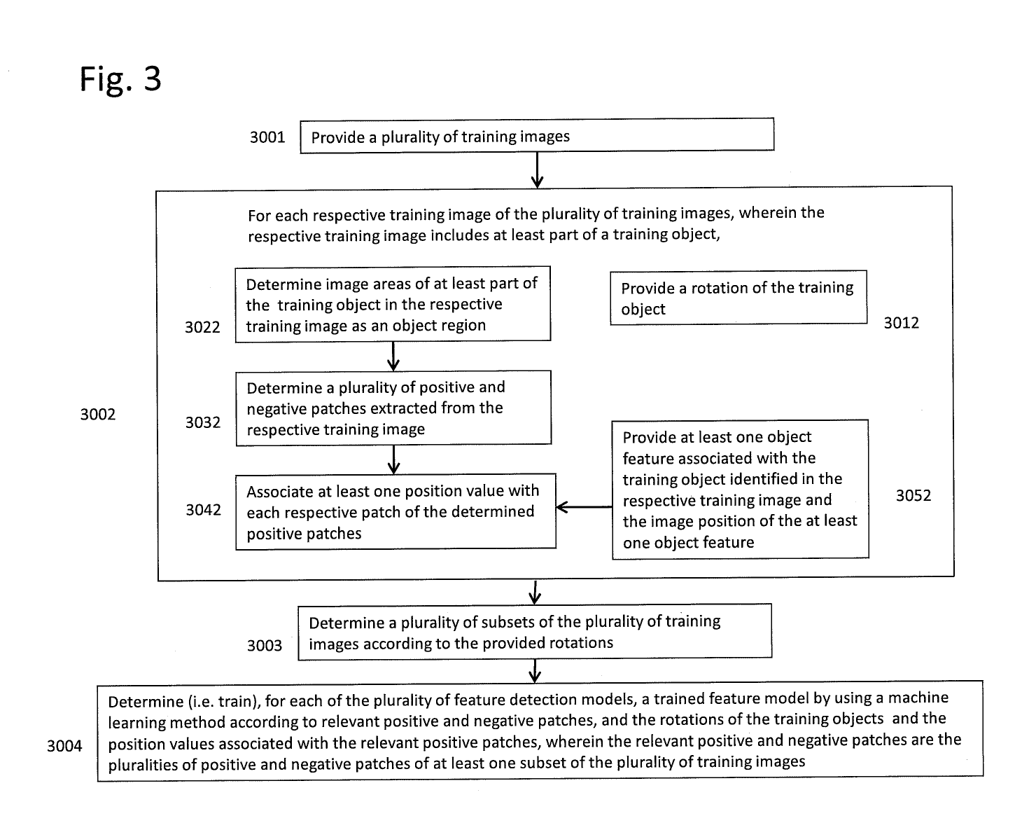

The different image appearances may require different methods and/or parameters to detect the object of interest and object features associated with the object of interest in the input image. Thus, it is proposed to choose a feature detection model from a plurality of feature detection models according to the estimated coarse pose in step 1004. An embodiment of determining or constructing a plurality of feature detection models is illustrated in FIG. 3. Each of the plurality of feature detection models may be associated with a range of rotations. If the estimated pose is determined to be within a certain range of rotations, then one of the feature detection models corresponding to that range is chosen.

For example, referring to an embodiment according to FIG. 7, it is possible to have five feature detection models for five categories of coarse poses, such as: ‘Left profile’, ‘left half profile’, ‘frontal’, ‘right half profile’, and ‘right profile’ may be defined as five categories of coarse poses of a face. ‘Left profile’ may be defined as between −100 degrees and −50 degrees of yaw rotation of the face (the image 7001 is one example image of the face indicative of ‘Left profile’). ‘Left half profile’ may be defined as between −50 degrees and −15 degrees of yaw rotation of the face (the image 7002 is one example image of the face indicative of ‘Left half profile’). ‘Frontal’ may be defined as between −15 degrees and +15 degrees of yaw rotation of the face (the image 7003 is one example image of the face indicative of ‘Frontal’). ‘Right half profile’ may be defined as between +15 degrees and +50 degrees of yaw rotation of the face (the image 7004 is one example image of the face indicative of ‘Right half profile’). ‘Right profile’ may be defined as between +50 degrees and +100 degrees of yaw rotation of the face (the image 7005 is one example image of the face indicative of ‘Right profile’).

Correspondingly, the used plurality of feature detection models includes a left profile feature detection model, a left half profile feature detection model, a frontal feature detection model, a right half profile feature detection model, and a right profile feature detection model. Each of the plurality of feature detection models may be associated with a range of rotations.

Referring again to FIG. 1, step 1005 determines object feature positions in the input image and optionally a refined pose of the object of interest according to the selected feature detection model and at least part of the input image. At least one object feature will be detected and its image position will be determined in step 1005.

In one example scenario shown in FIG. 6, object features of the human face in the input image 6003 are facial features such as eye corners 6010, nose tip 6011, and mouth corners 6012. Eye corners 6010, nose tip 6011, and mouth corners 6012 are point features, which are called fiducials.

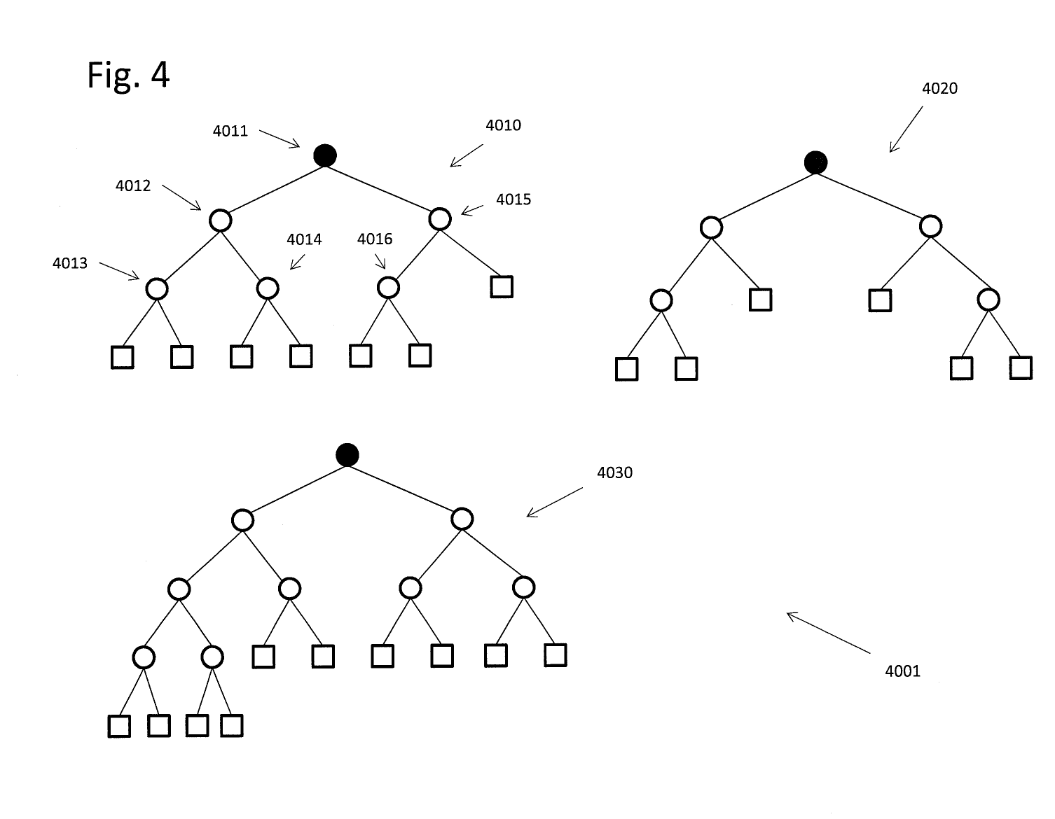

Particularly, the selected feature detection model has a trained forest structure comprising at least one decision tree. For example, the at least one decision tree may be a binary decision tree 4010 as shown in FIG. 4. At the nodes 4011, 4012, 4013 and 4015, the object poses are used for decision, while at the nodes 4014 and 4016, the object feature locations are used for decision.

In the present embodiment, the forest used in step 1005 is jointly trained for face pose and fiducial locations. The output from step 1005 may be, both, fiducial locations and face pose that is more refined than the coarse pose from step 1003. The joint training of face pose and fiducial locations is not disclosed in Dantone M., Gall J., Fanelli G., and van Gool L., Real-time Facial Feature Detection using Conditional Regression Forests, IEEE Conference on Computer Vision and Pattern Recognition (CVPR'12), 2012. In Dantone M., Gall J., Fanelli G., and van Gool L., Real-time Facial Feature Detection using Conditional Regression Forests, IEEE Conference on Computer Vision and Pattern Recognition (CVPR'12), 2012 the coarse pose estimation step returns a rough pose. The rough pose is then used to pick appropriate trees for estimating the fiducial locations. They do not estimate a refined face pose at the same time as estimating the fiducial locations. The present method of the invention, however, may estimate, both, fiducial locations and face pose (by using jointly trained forests) in step 1005.

The joint training does not really impact the online detection procedure (step 1005) much, except at the leaf nodes. The end result of the training is simply a test for each node that decides how to split the data that have reached the current node. In the leaf nodes, statistics for, both, fiducial locations and face pose are maintained. Any image patch that reaches a leaf hence votes for certain fiducial locations and face pose value. In Dantone M., Gall J., Fanelli G., and van Gool L., Real-time Facial Feature Detection using Conditional Regression Forests, IEEE Conference on Computer Vision and Pattern Recognition (CVPR'12), 2012, at the leaf nodes, only statistics for the fiducial locations are maintained. Hence the forest in Dantone M., Gall J., Fanelli G., and van Gool L., Real-time Facial Feature Detection using Conditional Regression Forests, IEEE Conference on Computer Vision and Pattern Recognition (CVPR'12), 2012 can only estimate fiducial locations.

The advantage of this two-phase system of first estimating a coarse pose and then estimating the feature locations is that in reality the locations of the features are heavily dependent on the pose of the object of interest (e.g. face). Direct estimation of the features from raw pixel data is extremely difficult. The subtasks of coarse pose estimation and then feature location estimation given a coarse pose are significantly easier and can be achieved to a high degree of accuracy.

Referring again to FIG. 1, the following steps 1006 to 1010 are part of a further embodiment of the invention. Step 1006, which is optional, performs tracking of the detected object features by using a Particle filter. Here, other filtering techniques are applicable as well. Occasional errors in detected features are corrected by the tracking of the object features. This helps in obtaining a more reliable pose estimate in the next steps. Detailed embodiments are further explained in below.

Step 1007 provides a 3D model. For example, the 3D model may be a wireframe model. Step 1008 then determines feature correspondences between the input image and the 3D model. For the example shown in FIG. 6, the 3D model is a model of a face. However, the face of the 3D model does not have to be the face 6002 whose pose needs to be estimated. Further, facial features, such as eye corners, nose tip, and/or mouth corners of the face of the 3D model could be extracted or provided with their 3D positions in the 3D model. Facial feature correspondences between the input image 6003 and the 3D model could be determined.

Step 1009 determines an accurate pose (in the sense of a non-coarse pose) of the object of interest according to the feature correspondences and determined object feature positions in the input image and 3D positions in the 3D model. For the example shown in FIG. 6, the accurate pose of the face 6002 is relative to the camera 6001. 2D image positions of the facial features 6010, 6011, and 6012 in the input image 6003 and 3D positions of the corresponding facial features in the 3D model can be used to estimate the accurate pose according to various 2D-3D point correspondences methods (such as disclosed in Haralick, Bert M., et al. “Review and analysis of solutions of the three point perspective pose estimation problem.” International Journal of Computer Vision 13.3 (1994): 331-356; Petersen, Thomas. “A Comparison of 2D-3D Pose Estimation Methods.” Master's thesis, Aalborg University-Institute for Media Technology Computer Vision and Graphics, Lautrupvang 15: 2750). In another implementation, features could be non-point features, like edges or eclipses. Non-point facial features could be a silhouette of the face, a silhouette of the mouth, an edge between two mouth corners, and an edge between two eye corners. Techniques disclosed in Agarwal, Anubhav, C. V. Jawahar, and P. J. Narayanan. “A survey of planar homography estimation techniques.” Centre for Visual Information Technology, Tech. Rep. IIIT/TR/2005/12 (2005) may be employed for pose estimation based on correspondences of non-point features and/or point features. In this step, the estimated coarse pose may be used as an initial guess for determining the accurate pose.

A significant contribution over the teachings in Dantone M., Gall J., Fanelli G., and van Gool L., Real-time Facial Feature Detection using Conditional Regression Forests, IEEE Conference on Computer Vision and Pattern Recognition (CVPR'12), 2012 is to use the feature correspondences with a 3D model that allows us to further track facial features and estimate expressions and emotions. We use a 3D model of the human head and starting from the estimated face pose from the random forest, we perform a 2D-3D correspondence matching from the observed face image to the 3D model. This helps to obtain a more accurate pose for the head and corrects for occasional errors in the fiducial estimation. Depending on the application, the 3D model can be of different amount of complexity. The proposed system can be used with simple 3D models that include only face points (such as the wireframe 3D model) to more complex models that include surface level detail of the head. For modeling face expressions and mouth movement, 3D morphable models can be used. Using a 3D morphable model allows the system to warp the 3D model to better fit the particular user whose face is being observed. Detailed 3D models are useful for augmented reality applications where augmenting the face surface is the goal.

Step 1010, which is optional, performs filtering and smoothing of the determined accurate pose using a Kalman filter. This is useful in two ways. (1) The filtered pose or location of the object of interest may be used as a good starting point for detecting the location and pose of the object of interest in the next image. (2) The filtering removes the jitter in the estimated pose values making the final output visually more pleasing for real applications such as augmented reality, gaming, gesture recognition, and human computer interaction systems. Detailed embodiments are explained herein below.

FIG. 2 shows a workflow diagram of an embodiment of determining a trained pose model. Step 2001 provides a plurality of training images. Like the input image, each respective training image of the plurality of training images may be a real image captured by a camera or a synthetic image. The synthetic image may be generated as captured by a camera. Each respective training image includes (e.g. captures or visualizes) at least part of a training object. A part of the plurality of the training objects captured in the plurality of training images may be the same or different objects. For example, a same human face may be captured in a plurality of images by one or more cameras. In another example, different faces of several different people may be captured in a plurality of images by one or more cameras.

Step 2002 includes steps 2012, 2022, and 2032 that are performed for each respective training image of the plurality of training images.

Step 2012 provides a ground truth pose (e.g. ground truth rotation) of the training object captured or visualized in the respective training image. The ground truth rotation may be relative to a camera that captures the respective training image. The ground truth rotations may be obtained by using suitable sensors or expensive and accurate tracking setups.

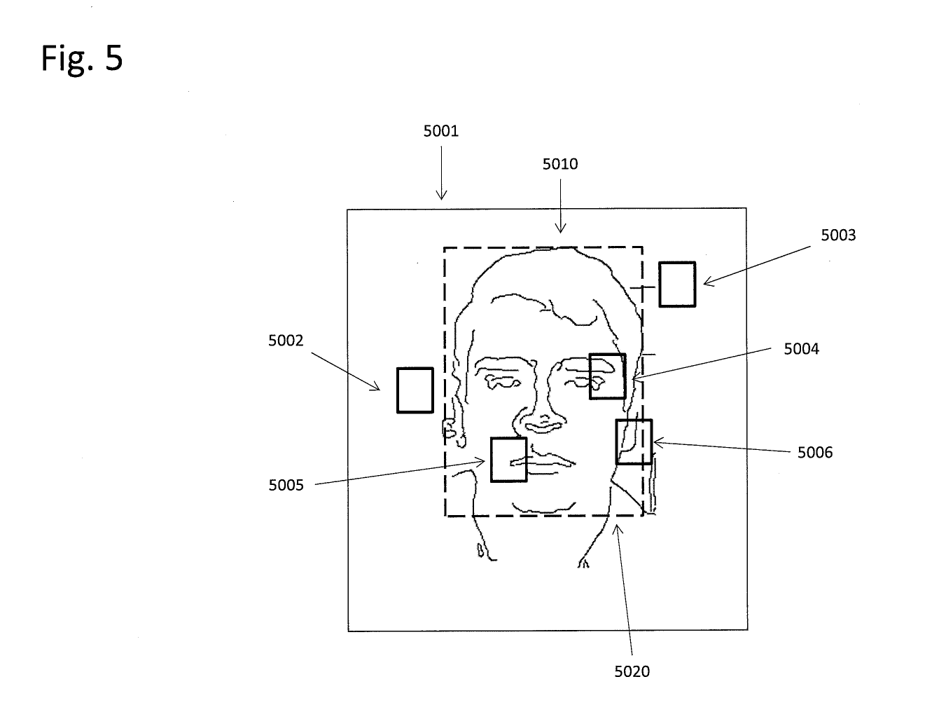

Step 2022 determines or provides image areas of at least part of the training object in the respective training image as an object region. There may exist one image area or more disconnected image areas of the at least part of the training object. In one example as shown in FIG. 5, the detection of the face 5010 using an off-the-shelf (commonly known) face detector generates the face bounding box 5020 (dash line) in the image 5001. In this case, the face bounding 5020 box is object region. Step 2032 determines or provides a plurality of positive and negative patches extracted from the respective training image. A patch is positive if the patch is within the object region and a patch is negative if the patch is out of the object region. When a part of a patch is within the object region and rest part of the patch is out of the object region, the patch is rejected and it is neither positive nor negative. A patch is an image region within the image, for example, a rectangle region. In one example as shown in FIG. 5, the patches 5002 and 5003 are negative patches. The patches 5004 and 5005 are positive patches. The patch 5006, which is rejected, is neither positive nor negative.

The patches extracted from the training images may have to be convolved with one or more filters. A filter response for a filter is a result after a patch is convolved with the filter. When multiple filters are used, one patch will have multiple filter responses. For example, the filter response may be a convolved patch that has the same dimension as the original patch. The filter response may also have different dimensions compared to the original patch. In the following steps of using machine learning methods to train the trained pose model, original patches and/or filter responses (e.g. convolved patches) may be used.

Step 2003 determines (i.e. trains) the trained pose model by using a machine learning method according to the plurality of positive and negative patches and the ground truth rotations. In one example, the trained pose model is a forest structure comprising a plurality of binary tree structures, wherein each leaf of the binary tree structures of the forest structure is associated with parameters about rotation. The parameters or values about rotation may be determined according to at least one of the ground truth rotations. The machine learning method could be a random forest method (as according to Breiman, Leo. “Random forests.” Machine learning 45.1 (2001): 5-32) or a rotation forest method (as according to Rodriguez, Juan Jose, Ludmila I. Kuncheva, and Carlos J. Alonso. “Rotation forest: A new classifier ensemble method.” Pattern Analysis and Machine Intelligence, IEEE Transactions on 28.10 (2006): 1619-1630) for determining the forest structure. FIG. 4 shows a forest structure 4001 comprising three binary trees 4010, 4020, and 4030. For each of the binary trees, circles with and without fill indicate an internal node and squares indicate leafs. The circles with the fill indicate the root and each of the binary trees has one root node.

In one embodiment of determining the trained pose model for determining face pose, a set of patches (typically a few tens) are extracted from each training image (example patches are 5001-5006 shown in the FIG. 5). Patches that happen to lie on the face (face regions are marked in the training images) are considered ‘positive’ patches and patches that do not lie on the face are ‘negative’ patches. The ground truth poses of the face for each training image may be stored along with the patch information. The goal of the model is to then learn an association between the information in the patches and the expected output variable. Many machine learning models such as boosting and Support Vector Machines can be used for this purpose.

Random forests (such as disclosed in Breiman, Leo. “Random forests.” Machine learning 45.1 (2001): 5-32) may be used to train the pose model, which are known for their robustness and learning ability. The random forest algorithm can be replaced by any suitable machine learning algorithm. The learning algorithm for the random forest implementation basically learns a tree where a decision is made at each internal node on how to split the observed patches into two subsets. The decision rule at each internal node acts as a test that determines which subtree (left or right) to push an observed patch to. The key to learning an effective random forest is to ensure that the split made at each node results in subtrees that are meaningful towards the eventual goal (estimating the rotation of the face). This is achieved by choosing a decision rule (from a set of randomly generated rules) that splits the patches into two groups such that the sum of the entropies of the distribution of rotation values in the two groups is minimized. In practice, a decision rules consists of two rectangular regions within the patch and a threshold value. If the difference between the cumulative feature values of the two rectangles is greater than the threshold, the patch is considered to have passed the test and sent to the left subtree. If the difference is less than the threshold value, then the patch fails the test and is sent to the right subtree. By cumulative feature values, it means the sum of all feature values within the given rectangular region. The rectangular regions are generated to be of random size and at random locations within the given patch. The thresholds for each decision rule are picked from a set of randomly generated threshold values. When a given maximum depth is reached or number of patches reaches a node, a node is considered to be a leaf and the mean and variance of all the rotation values are computed for patches that have reached the leaf. When all the input patches have been pushed to their destination leaf nodes, the training phase of one tree is complete. Multiple trees are learned with different decision rules thus resulting in a forest of trees.

FIG. 3 shows a workflow diagram of an embodiment to determine a plurality of feature detection models. Step 3001 provides a plurality of training images similar to step 2001. Step 3002 includes steps 3012, 3022, 3032, 3042, and 3052 that have to be performed for each respective training image of the plurality of training images. Similar to step 2022, step 3022 determines or provides image areas of at least part of the training object in the respective training image as an object region. Similar to step 2032, step 3032 determines or provides a plurality of positive and negative patches extracted from the respective training image. The patches extracted from the training images may have to be convolved with one or more filters. In the following steps that need the patches, original patches and/or filter responses (e.g. convolved patches) may be used.

Step 3012 determines a rotation of the training object according to the trained pose model or provides a ground truth pose (e.g. ground truth rotation) of the training object. Step 3052 provides at least one object feature associated with the training object identified in the respective training image and an image position of the at least one object feature. One or more object feature may be manually or automatically identified with their image positions in the respective training image. Step 3042 associates at least one position value with each respective patch of the determined positive patches, wherein the at least one position value is determined according to an image position of the respective patch and the image position of the at least one object feature. The image position of the respective patch may be defined in the center or a corner of the patch.

For example, the at least one position value may be a 2D vector that joins the center of the respective patch to the image position of one object feature provided in step 3052. Multiple 2D vectors that join the center of the respective patch to the image positions of multiple object features provided in step 3052 may be associated with the respective patch.

Step 3003 determines a plurality of subsets of the plurality of training images according to the determined rotations. In one implementation, training images, based on which the rotations are determined within predefined up and low boundaries (e.g. within −30 degrees and +30 degrees around yaw rotation of the face), may be added to one subset.

Then step 3004 determines, for each of the plurality of feature detection models, a trained feature model by using a machine learning method according to relevant positive and negative patches, and the position values associated with the relevant positive patches, wherein the relevant positive and negative patches are the pluralities of positive and negative patches extracted in at least one subset of the plurality of training images.

For a training object locating at different poses relative to the camera, the camera would capture different image appearances of the training object in the training images. For example, the camera would capture different image appearances of a face in the training images when the face locates at different poses relative to the camera (see FIG. 7). Particularly, different rotations will make significant image appearances compared to different translations. Training images that have similar image appearances resulted from similar rotations should be grouped and used to train a specific feature model that could best fit to estimate the result of new data that also has the similar rotation. Thus, the present invention proposes to construct different trained feature models for different image appearances of the object of interest in different input images.

In one embodiment, the plurality of training images are divided into five subsets depending on the estimated face yaw rotations for each training image. The five subsets may be ‘left profile’, ‘left half profile’, ‘frontal’, ‘right half profile’, and ‘right profile’ as explained above. The five subsets of the training images are then used to train five different feature models using machine learning methods.

For each of the plurality of feature detection models, the trained feature model may be a forest structure comprising a plurality of binary tree structures, wherein each leaf of the binary trees of the forest structure is associated with values about feature locations and poses of the training objects.

A similar training procedure of constructing a forest using random forests mentioned above in step 2003 could also be employed here to build the forest for each of the plurality of feature detections.

A further significant contribution over the teachings according to Dantone M., Gall J., Fanelli G., and van Gool L., Real-time Facial Feature Detection using Conditional Regression Forests, IEEE Conference on Computer Vision and Pattern Recognition (CVPR'12), 2012 is to perform joint feature location detection and pose estimation. The plurality of feature detections is trained by a machine learning method (e.g. using random forest) using, both, poses and object features in the present invention. In contrast, Dantone M., Gall J., Fanelli G., and van Gool L., Real-time Facial Feature Detection using Conditional Regression Forests, IEEE Conference on Computer Vision and Pattern Recognition (CVPR'12), 2012 proposes to use only object features for training without considering poses. According to the present invention, forests associated with each of the plurality of feature detections may be trained according to a random forest method (see Breiman, Leo. “Random forests.” Machine learning 45.1 (2001): 5-32) with poses and object features associated with the training images. Before the training, the poses may be ground truth poses obtained by using suitable sensors or expensive and accurate tracking setups. The poses may also be coarse poses estimated by the trained pose model or by any other pose estimation methods. Object features and their image locations may be labeled manually or detected automatically.

According to an embodiment of the present invention, the forest may be trained using, both, pose and feature location and the tree makes the decision of what information to split at each node based on maximizing the information gain. The advantage of joint estimation is that the feature locations are not treated as independent, but are now linked to each other through the pose which improves the feature location detection performance and reduces the error from independent detections. Particularly, the rotational component of the pose has a strong influence on feature locations in the image.

In the example of facial feature detection, Dantone M., Gall J., Fanelli G., and van Gool L., Real-time Facial Feature Detection using Conditional Regression Forests, IEEE Conference on Computer Vision and Pattern Recognition (CVPR'12), 2012 estimates only facial fiducial locations. In embodiments of the current disclosed method, however, the pose and facial fiducial locations are learned in a joint fashion within the same tree. This is beneficial because the face pose and facial fiducial locations are found to be heavily dependent on each other in the real world. Jointly training for pose and facial fiducial locations helps to model this strong dependency. In a random forest, during training of each node, the data is split into two subsets depending on some test. The tests are chosen such that the split sets maximize the information gain in the system, making it easier to split the subsets in turn. In our system, the test for each node is chosen from two types of tests—one that performs a split based on the facial fiducial location estimates of the data and another that performs a split based on the face pose estimates of the data. At each node, the test that results in the highest information gain from these two types of tests is chosen automatically during the training phase. The result is that at each node, either the face pose or the facial fiducial locations are used as the criterion for the decision. Thus, the dependency between face pose and facial fiducial locations is jointly encoded within the random forest. In all leaf nodes of the tree, statistics for both fiducial locations and face pose are maintained. Any image patch that reaches a leaf hence votes for certain fiducial locations and face pose value.

An implementation based on random forests for step 1003 is described below for estimating the coarse pose of the object of interest according to the trained pose model. In the scenario shown in FIG. 6, when the random forest is to be used to estimate the coarse pose from the input image, patches are extracted (either at random or in a dense sampling scheme) from the input image using face detection. The extracted patches may have to be convolved with one or more filters. In the following steps that need the patches, original patches and/or filter responses (e.g. convolved patches) may be used. Then, the patches are propagated through the trained pose model (i.e. a trained forest of binary trees in this example). When the patches reach leaf nodes, the trained mean and variance values for profile angle values at these leaves are used to estimate the coarse pose for the observed face image. Mean shift or other robust techniques are used to obtain a confident solution from multiple trees in the forest.

The method described above could also be used for step 3012 of determining a rotation of the training object according to the trained pose model.

An implementation based on random forests for step 1005 is described below for determining object features and their image positions in the input image according to the chosen feature detection model. In the scenario shown in FIG. 6, after the forest of the chosen feature detection model has been trained, the presence of face in the input image is determined by using a face detector. Then the detected facial region (a bounding box) and the extracted patches (see below) are fed in to the trained forest. The patches from the input image are pushed down the trained forest until they reach the leaves. This identifies the positive (facial) pixels (e.g. located at the center of a patch). Additionally, each of these leaves, at which the patches reach, each votes for feature locations and/or at least one object pose. All the votes are accumulated and by finding the mode of the distribution over candidate feature locations and at least one object pose separately, and the feature locations and the object pose are obtained for the input image. This is the mean-shift algorithm that finds the mode of the cluster.

For smoothing the fluctuations at each image of the feature location, a Kalman or particle filter may be used. This provides a smooth trajectory of points and also provides detection when random forests fail to provide feature locations in an intermediate image.

In Augmented Reality (AR) applications, virtual visual content (like a computer generated object) may be overlaid onto an image of an object of interest captured by a camera based on a pose of the object of interest relative to the camera. In one example of AR applications, a virtual glasses may be generated and overlaid onto an image of a human head captured by a camera. The pose of the head relative to the camera could be generated according to the method disclosed in this invention. The virtual glasses may be overlaid onto the image of the head according to the determined pose in order to have a realistic position in the image. The current invention of determining poses of the head may be used in AR shopping applications, e.g. shopping glasses, hats, and ear rings.

Generally, the following aspects and embodiments may be applied in connection with aspects of the present invention.

Image:

An image (e.g. an input image or training image) is any data depicting or recording visual information or perception. An image could be 2 dimensional, 3 dimensional, or N dimensional. The image could be a real image or a synthetic image. The real image may be captured by a camera capturing a real environment. For example, the camera may capture an object of interest or a part of the object of interest placed in a real environment in a real image. The synthetic image may be generated automatically by a computer or manually by a human. For example, a computer rendering program (e.g. based on openGL) may generate a synthetic image of an object of interest or a part of the object of interest. The synthetic image may be generated from a perspective projection as it is captured by a pin-hole camera. The synthetic image may be generated according to orthogonal projection.

The present invention can be applied to any camera providing images. It is not restricted to cameras providing color images in the RGB format. It can also be applied to any other color format and also to monochrome images, for example to cameras providing images in grayscale format or YUV format. The camera may further provide an image with depth data. The depth data does not need to be provided in the same resolution as the (color/grayscale) image. A camera providing an image with depth data is often called RGB-D camera. An RGB-D camera system could be a time of flight (TOF) camera system or a passive stereo camera or an active stereo camera based on infrared structured light. In this invention a light field camera may further be used.

Object:

An object (e.g. an object of interest or training object) may be any real object or computer-generated object. A real object may be any object existing in a real environment and having physical appearance or structure. For example, the real object may be a person, a face of a person, or a heart of a person. The real object could also be a tree, a car, a paper or a city. The real object may be captured by a camera in an image. The real object may also be visualized in a synthetic image.

A computer-generated object may be generated by a computer and have visual appearance. The computer-generated object could be a computer-generated figure, e.g. a computer-generated 2D or 3D model of human head. The computer-generated object may be displayed on a screen or projected to a wall using a projector. The computer-generated object may be captured by a camera by using the camera to take an image of the screen or the wall while displaying the object. The computer-generated object may also be recorded or visualized in a synthetic image.

Feature:

Object features associated with an object may be, but are not limited to, points, edges, lines, segments, corners, or any other geometrical shape of an object. Object features may also be color information or textures of the object. For example, facial features associated with a face could be eye corners, nose tips, mouth corners, silhouette of mouth, silhouette of eye, and color of skin or eye. Object features of an object may be visualized or captured in an image of at least part of the object. Object features may also be represented in a 3D model of the object. The position of an object feature in the image or in the 3D model may be represented by one or more coordinates or represented by one or more mathematical formulas. For example, a circle or a sphere may be represented by a set of points or by an equation in a 2D or 3D coordinate system. The circle that is a 2D geometry may be defined in a 2D or 3D space. The sphere that is a 3D geometry may be defined in a 2D space as a projection of the sphere (i.e. 3D shape) onto the 2D space.

Object features may also be represented by feature descriptors that describe the texture of features in an image patch. The feature descriptors are mathematical representation describing local features in images or image patches, such as SIFT (Scale-invariant feature transform), SURF (Speeded Up Robust Features), and LESH (Local Energy based Shape Histogram). The image features extracted from the image are such as but not limited to intensities, gradients, edges, lines, segments, corners, descriptive features or any other kind of features, primitives, histograms, polarities or orientations.

Pose:

A pose (e.g. coarse pose or accurate pose) of an object describes a rigid transformation including a translation and/or a rotation between the object and a reference object or a reference coordinate system. A pose of an object (e.g. an object of interest or training object) may be determined relative to a camera. For example, when the object is captured in an image by a camera or the object is visualized in an image that is synthetically generated as captured by a camera, the pose of the object relative to the camera can be determined based on the image using various computer vision methods (such as disclosed in Haralick, Bert M., et al. “Review and analysis of solutions of the three point perspective pose estimation problem.” International Journal of Computer Vision 13.3 (1994): 331-356; Petersen, Thomas. “A Comparison of 2D-3D Pose Estimation Methods.” Master's thesis, Aalborg University-Institute for Media Technology Computer Vision and Graphics, Lautrupvang 15: 2750).

A pose of an object (e.g. an object of interest or training object) may be relative to an arbitrary reference object. The pose of the object may be relative to the object itself at another position. For example, a face at a specific position is defined as a reference position, and then the pose of the face at a current position may describe a rigid transformation between the face at the current position and the reference position.

3D Model:

A 3D model may describe a geometry for an object or a generic geometry for a group of objects. In one example, a 3D model may be specific for an object. In another example, a 3D model may not be specific for an object, but describes a generic geometry for a group of similar objects. The similar object may belong to the same type and share some common properties. For example, faces of different people are the same type and they are a face that has eye, mouth, ear, nose, etc. Cars of different types or brands are the same type and they are a car that has four tires, at least two doors, and a front window glass, etc. A 3D model of a face may not be the same as any real existing individual face, but it is similar to the existing individual face. For example, the silhouette of the face of the 3D model may not exactly match the silhouette of the existing individual face, but they are all the shape of eclipse.

Geometry refers to one or more attributes of the object including, but not limited to, shape, form, surface, symmetry, geometrical size, dimensions, and structure. The model of the real object or the computer-generated object could be represented by a CAD model, a polygon model, a point cloud, a volumetric dataset, an edge model, or use any other representation. The model may further describe the material of the object. The material of the object could be represented by textures and/or colors in the model. A model of an object may use different representations for different parts of the object.

The 3D model can further, for example, be represented as a model comprising 3D vertices and polygonal faces and/or edges spanned by these vertices. Edges and faces of the model may also be represented as splines or NURBS surfaces. The 3D model may in this case be accompanied by a bitmap file describing its texture and material where every vertex in the polygon model has a texture coordinate describing where in the bitmap texture the material for this vertex is stored. The 3D model can also be represented by a set of 3D points as for example captured with a laser scanner. The points might carry additional information on their color or intensity.

The 3D model may also be a bitmap. In this case, the geometry of the object is a rectangle while its material is described for every pixel in the bitmap. Additionally, pixels in the bitmap might contain additional information on the depth of the imaged pixel from the capturing device. Such RGB-D images are also a possible representation for the 3D model and comprise both information on the geometry and the material of the object.

Trained Pose Model:

A trained pose model is a model constructed or trained according to a machine learning method with a plurality of training data. The training data could include images (i.e. training images) of one or more training objects. The one or more training objects may be the same or different. Poses of the training objects of the training images may be included in the training data. The trained pose model could be used to estimate a pose of an object of interest according to an image of at least part of the object of interest, wherein the object of interest may be the same as or different from the one or more training objects captured in the training images.

For example, the trained pose model may be a decision tree structure or a forest structure consisting of at least one decision tree. The decision tree or the forest could be constructed by various decision tree learning methods, such as bagging, random forest (Breiman, Leo. “Random forests.” Machine learning 45.1 (2001): 5-32)), and rotation forest (Rodriguez, Juan Jose, Ludmila I. Kuncheva, and Carlos J. Alonso. “Rotation forest: A new classifier ensemble method.” Pattern Analysis and Machine Intelligence, IEEE Transactions on 28.10 (2006): 1619-1630). The trained pose model may also be constructed by support vector machine (SVM) methods.

Feature Detection Model:

A feature detection model could be used to detect object features of an object of interest in an image of at least part of the object of interest and to determine image positions of the detected object features. Further, the feature detection model could also determine a pose of the object of interest according to the image.

The feature detection model may be associated with a trained feature model that could be constructed by a machine learning method with a plurality of training data. The training data could include images (i.e. training images) of one or more training objects. The one or more training objects may be the same or different. Further, the object of interest may be the same as or different from the one or more training objects. Object features associated with the training objects in the training images may be determined or provided for training. The training data may also include the identified object features and their image positions in the training images. The training data may further include poses of the training objects. For example, a trained feature model may be a decision tree structure or a forest structure comprising at least one decision tree. The decision tree or the forest could be constructed by various decision tree learning methods, such as bagging, random forest, and/or rotation forest. The trained pose model may also be constructed by support vector machine (SVM) methods. For example, the decision tree may be a binary decision tree (e.g. binary trees 4010, 4020, and 4030 in FIG. 4).

Particularly, for training the feature model, the at least one decision tree of the forest may be trained with a joint pose and fiducial (i.e. object feature) estimation. Point feature is also called fiducial. For example, an eye corner or a mouth corner is a facial fiducial. According to embodiments of the invention, the pose and fiducial locations (locations in a 2D image) are learned in a joint fashion within one decision tree. This is beneficial because the face pose and fiducial locations are heavily dependent on each other in the real world. Jointly training for pose and fiducial locations helps to model this strong dependency.

In a random forest, during training of each node of the decision tree, input data is split into two subsets depending on some test. The tests are chosen such that the split sets maximize the information gain in the system, making it easier to split the subsets in turn. In our system, the test for each node is chosen from two types of tests—one that performs a split based on the fiducial location estimates of the data and another that performs a split based on the face pose estimates of the data. At each node, the test that results in the highest information gain from these two types of tests is chosen automatically during the training phase. The result is that at each node, either the face pose or the fiducial locations are used as the criterion for the decision. Thus, the dependency between face pose and fiducial locations is jointly encoded within the random forest.

In the example of tree 4010 of FIG. 4, trained in a joint pose and fiducial estimation, at the nodes 4011, 4012, 4013 and 4015, the object poses are used for decision, while at the nodes 4014 and 4016, the object feature locations are used for decision.

Tracking Object Features:

Tracking of object features of an object across multiple images is a useful process when the goal is to track or estimate the pose of the object. For face pose estimation, tracking of features such as eyes and nose can help in estimating the overall pose of the face. Tracking can help to correct occasional errors in the feature detection process based on a single image and also smooth out jitter which is commonly observed in the detection process. The particle filter tracker (see, e.g., reference [8]) is a robust tracking algorithm for objects in image sequences. The basic idea behind particle filtering is to maintain multiple hypotheses for the state of the object, called particles, which are repeatedly sampled in the system. The state may consist of the location, orientation, velocity, and scale of the object and/or object features in 2D image or 3D space being tracked. Given a representation of the target object (say the image patch that encloses the object), the probability of match between each particle and the target is computed. The estimated state of the target is a weighted sum of the particle states, weighted by the match probabilities.

In the proposed system, the location of the features (image position, e.g. x,y), their size (bounding box width, height), and velocity (along x and y directions in image) compose the 6-dimensional state vector. The histogram of colors observed in the image patch around each feature is used as the representation for computing the probability of match between the particles and the target feature. The probability of match is based on the Bhattacharya coefficient between the particle patch and the target feature patch. At each frame, new particles are sampled based on the particles' previous states and match probabilities. The match probabilities between the newly sampled particles and the target feature patch are computed. The estimated state of the feature in the current frame (i.e. image) is obtained as a weighted sum of the particle states. From the estimated state, the location and size of the feature is known. Using the location and size of the tracked features, the pose of the face can be estimated. To account for the changing appearance of the features due to the change in face pose and varying lighting in the scene, the target histogram is updated by blending the previous frame target histogram with the histogram observed in the predicted feature location in the current frame. To achieve robustness to lighting changes, HSV color histograms are used instead of RGB color. Local binary patterns (LBP) is another robust representation using which histograms can be computed. Other representations including Gabor filters and steerable filters are also useful for more robust tracking in of features. Further, the state can be enhanced to include the rotation of the features, bounding ellipse parameters, affine transformation parameters, acceleration of the features, etc.

Face pose tracking for smooth output:

For detecting object features associated with an object and estimation the coarse and accurate pose of the object from images, knowing an estimated location of reference point of the object in the image, can help achieve higher processing speed and accuracy. The reference point could be chosen if the point changes only by a few pixels from one frame to the next. For a face object, in most practical settings, the face center changes only by a few pixels from one frame to the next. The face center (e.g. nose tip) from the previous frame can be used as the expected location of the face center in the current frame. This assumption works well in a majority of the frames. However occasionally the face position changes by more than a few pixels and the above approximation fails. To avoid this situation, we use a tracking approach of Kalman filtering to track and smooth the estimated location of the nose tip.

A Kalman filter, as described in Kalman, R. E. “A new approach to linear filtering and prediction problems”. Journal of Basic Engineering 82 (1): pp. 35-45, is a 2-step filtering process that maintains a state for the object being tracked and uses the observations from the data to update the state. The state may consist of the location, orientation, velocity, and scale of the object and/or object features in 2D image or 3D space being tracked. The first step is to predict the state in the current frame based on the state in the previous frame. The second step is to update the predicted state by taking into account the observations in the current frame. In the proposed system, the nose tip location (x,y,z values) and velocity of the nose tip (along x,y,z directions) are maintained as the state. The observations are the predicted nose tip location from the pose estimation algorithm. In frames where the algorithm returns a reliable nose tip estimate, the Kalman prediction and update steps are performed to obtain the filtered nose tip location. In frames where the algorithm does not return a reliable nose tip estimate, only the Kalman prediction step is performed. This allows the Kalman filter to continuously track and smooth the face center. By varying the covariance values associated with the states and the observations in the Kalman filter, the filter can be designed to track the observations with different amount of lags. The usefulness of the Kalman filter is in estimating a good prediction for the estimated nose tip when the pose estimation algorithm fails to obtain a confident pose prediction using the previous frame's unfiltered nose tip. The Kalman filter can be replaced by extended Kalman filters (EKF) and other variations of Kalman filters to model more complex tracking scenarios. The state of the object can be enhanced to include the object's acceleration, orientation, bounding ellipse, size, etc. While the proposed system tracks only the face center location, tracking of the face pose in addition to the face center location would also be useful.

As described herein, embodiments of the present invention determine an accurate (in the sense of non-coarse) pose of the object. An aspect of the invention first uses a trained pose model to estimate a coarse pose, and then determines object features in the image by using a trained feature model that is selected from a plurality of trained feature models according to the estimated coarse pose. The trained feature model may be determined by a joint training procedure according to, both, poses and object feature locations obtained from a plurality of training images. The trained feature model, for example, could be a forest structure comprising at least one binary decision tree, which is determined or trained by using a random forest method (such as disclosed in Breiman, Leo. “Random forests.” Machine learning 45.1 (2001): 5-32). Then, an accurate pose may be determined according to the determined object features.

In an embodiment, the decision tree comprises internal nodes, each of the internal nodes being associated with a test, wherein for at least part of the internal nodes of the decision tree, the test is determined according to at least part of the image positions of object features of the training objects, and for at least part of the internal nodes of the decision tree, the test is determined according to at least part of the poses of the training objects.

For example, for each respective training image of the plurality of training images, the respective training image is an image of a real environment captured by a camera or a synthetic image generated as captured by a camera, and the known pose of the respective training object is relative to the camera.

Although various embodiments are described herein with reference to certain components or devices, any other configuration of components or devices, as described herein or evident to the skilled person, can also be used when implementing any of these embodiments. Any of the devices or components as described herein may be or may comprise a respective processing device (not explicitly shown), such as a microprocessor, for performing all or some of the tasks as described herein. One or more of the processing tasks may be processed by one or more of the components or their processing devices which are communicating with each other, e.g. by a respective point to point communication or via a network, e.g. via a server computer.

1. A method of determining at least one object feature of at least one object comprised in an image, comprising the steps of:
providing an input image of at least part of the at least one object;
estimating a coarse pose of the at least one object according to a trained pose model and at least part of the input image;
selecting a feature detection model from a plurality of feature detection models according to the estimated coarse pose; and
determining at least one object feature position of the at least one object in the input image according to the selected feature detection model and at least part of the input image;
wherein the selected feature detection model includes a forest data structure comprising at least one decision tree having leaf nodes, wherein at least part of the leaf nodes of the at least one decision tree is associated with statistics for at least one object feature position and statistics for at least one pose.

2. The method according to claim 1, further comprising the step of determining a refined pose of the at least one object according to the selected feature detection model and at least part of the input image.

3. The method according to claim 1, further comprising the steps of:
providing a 3D model;
determining object feature correspondences between object features in the input image and features of the 3D model; and
determining an accurate pose of the at least one object according to the object feature correspondences.

4. The method according to claim 1, wherein the at least one decision tree is determined by using a machine learning method based on a plurality of training images of training objects which are associated with known image positions of object features of the training objects and known poses of the training objects.

5. The method according to claim 4, wherein each of the poses of the training objects includes at least one parameter indicative of a rotation.

6. The method according to claim 4, wherein the at least one decision tree comprises internal nodes, each of the internal nodes of the at least one decision tree being associated with a test, and
for at least part of the internal nodes of the at least one decision tree, the test is determined according to at least part of the image positions of object features of the training objects; and
for at least part of the internal nodes of the at least one decision tree, the test is determined according to at least part of the poses of the training objects.

7. The method according to claim 1, wherein the input image is an image of a real environment captured by a camera or is a synthetic image generated as captured by a camera.

8. The method according to claim 7, wherein at least one of the estimated coarse pose and the determined accurate pose is relative to the camera.

9. The method according to claim 1, wherein the at least one object is a face, and the at least one object feature is a facial feature.

10. The method according to claim 9, wherein the facial feature is at least one of an eye corner, a nose tip, a mouth corner, a silhouette of mouth, or a silhouette of eye.

11. The method according to claim 1, wherein the coarse pose of the at least one object includes at least one parameter indicative of a rotation.

12. The method according to claim 4, wherein for each respective training image of the plurality of training images, the respective training image is an image of a real environment captured by a camera or a synthetic image generated as captured by a camera, and the known pose of the respective training object is relative to the camera.

13. The method according to claim 1, wherein the at least one object is a face having a left profile, a left half profile, a front, a right half profile, and a right profile; and
the plurality of feature detection models includes a left profile feature detection model, a left half profile feature detection model, a frontal feature detection model, a right half profile feature detection model, and a right profile feature detection model; and
wherein each of the plurality of feature detection models is associated with a range of rotations.

14. A non-transitory computer readable medium comprising software code sections which are adapted to perform a method for determining at least one object feature of at least one object comprised in an image when running on a processing device, the method comprising:
providing an input image of at least part of the at least one object;
estimating a coarse pose of the at least one object according to a trained pose model and at least part of the input image;
selecting a feature detection model from a plurality of feature detection models according to the estimated coarse pose; and
determining at least one object feature position of the at least one object in the input image according to the selected feature detection model and at least part of the input image;
wherein the selected feature detection model includes a forest data structure comprising at least one decision tree having leaf nodes, wherein at least part of the leaf nodes of the at least one decision tree is associated with statistics for at least one object feature position and statistics for at least one pose.

15. A device for determining at least one object feature of at least one object comprised in an image, comprising at least one processing device which is configured to:
provide an input image of at least part of the at least one object;
estimate a coarse pose of the at least one object according to a trained pose model and at least part of the input image;
select a feature detection model from a plurality of feature detection models according to the estimated coarse pose; and
determine at least one object feature position of the at least one object in the input image according to the selected feature detection model and at least part of the input image;
wherein the selected feature detection model includes a forest data structure comprising at least one decision tree having leaf nodes, wherein at least part of the leaf nodes of the at least one decision tree is associated with statistics for at least one object feature position and statistics for at least one pose.

16. The device according to claim 15, the at least one processing device further configured to determine a refined pose of the at least one object according to the selected feature detection model and at least part of the input image.

17. The device according to claim 15, the at least one processing device further configured to:
provide a 3D model;
determine object feature correspondences between object features in the input image and features of the 3D model; and
determine an accurate pose of the at least one object according to the object feature correspondences.
